(19) United States
(12) Patent Application Publication
(10) Pub. No.: US 2011/0231236 A1
(43) Pub. Date: Sep. 22, 2011

(54) Coupon System and Method

(76) Inventor: Felipe Gonzalez, San Antonio, TX (US)

(21) Appl. No.: 12/728,000

(22) Filed: Mar. 19, 2010

(51) Int. Cl. G06Q 30/00; G06Q 50/00; G06F 17/00

(52) U.S. Cl. 705/14.25; 705/14.38; 235/375; 340/10.1

(57) ABSTRACT

Systems and methods for promotions of selected products in a retail grocery setting include providing electronic coupons for immediate use. Customers are provided an RFID tag that can communicate with RFID devices placed on the grocery shelves adjacent or near the selected products. Touching or approaching the shelf devices with a tag transfers the coupon information to the tag, and an RFID reader at the point of sale retrieves the coupon information and applies the discounts at checkout.

### BACKGROUND

Discount coupons are an important aspect of the retail grocery industry for increasing sales and fostering brand and store loyalty. A Promotion Marketing Association survey in 2008 found that 89 percent of the respondents reported using coupons when shopping (for grocery, household and healthcare items at supermarkets), 97 percent of primary shoppers said that they use coupons at supermarkets, and coupon users reported an average of 7 percent savings on their grocery bills with coupons. The association further reported that over $350 billion of packaged goods coupons were offered yearly, the average value was about $1.25 per coupon, and that consumers save about $2.6 billion annually using manufacturers' coupons when shopping for packaged products. The Association further reported that coupon use by consumers held steady in 2008 as compared to the previous year, which stopped a fifteen year trend of decline in annual coupon redemption.

As of September 2008 almost 90 percent of all coupons were issued in Sunday newspaper supplements, but coupons were also available directly in many retailers' ads or stores, in magazines, in and on product packaging, on the Internet, and in consumers' mailboxes. Electronic coupons are gaining in popularity and typically are provided to consumers through a loyalty card or membership account. There is still a need, however, for electronic coupons that can be delivered to customers with no prior membership or account information.

### SUMMARY

The present disclosure is directed to methods and systems for promotions of selected products in a retail grocery setting by providing electronic coupons for immediate use. In certain preferred embodiments customers are provided an RFID tag that can communicate with RFID devices placed on the grocery shelves adjacent or near the selected products. Touching or approaching the shelf devices with a tag transfers the coupon or ID information to the tag, and an RFID reader at the point of sale retrieves the coupon information and applies the discounts at checkout.

Throughout this disclosure, unless the context dictates otherwise, the word “comprise” or variations such as “comprises” or “comprising,” is understood to mean “includes, but is not limited to” such that other elements that are not explicitly mentioned may also be included. Further, unless the context dictates otherwise, use of the term “a” or “the” may mean a singular object or element, or it may mean a plurality, or one or more of such objects or elements.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a diagram of an embodiment of a system of the disclosure.

FIG. 2 is a diagram of an embodiment of a store shelf device.

### DETAILED DESCRIPTION

The present disclosure provides systems and methods of increasing the use of coupons in a retail grocery setting by providing paperless, instantly redeemable coupons to customers at grocery shelf locations. The systems and methods further provide retailers an effective tool for encouraging customers to select certain products, to visit certain areas of a retail store, and to return to a particular store for future shopping needs.

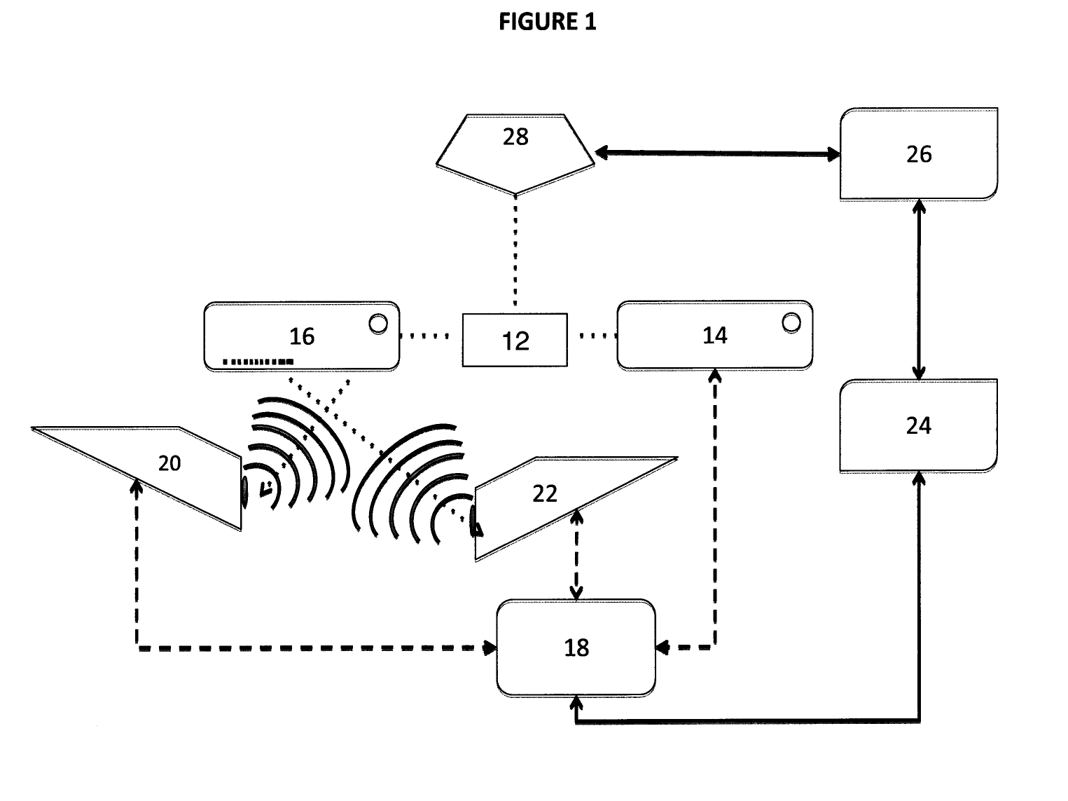

FIG. 1 is a diagram of an example of a system that can be used in the practice of the disclosed methods. A first component of the system 10, is the RFID tag shown in the center of the diagram and labeled 12. Any of a number of RFID tags known in the art can be used in the systems and methods of the present disclosure. A typical tag can include electronic circuitry to receive and store information and an antennae for wireless or radiofrequency (RF) communication.

The RFID tag is provided to a customer for use during a shopping trip to retrieve coupon information from shelf devices and transport that information to the point of sale to receive credit for the coupon discounts. In certain embodiments a tag is provided to a customer upon entering the store for use during that trip and then returned to the store upon checkout. In other embodiments, a customer can keep the tag for future visits to the issuing store. In this way, information about coupons used by the holder of the tag can be collected by the point of sale server and used to track customer coupon use. This gives the retailer a basis for offering additional or future coupon discounts. In certain embodiments, for example, a kiosk can be provided by the retailer such that when a customer returns with a previously used tag, the kiosk can be tapped with the tag and such action provides coupons to that tag based on previous use.

It is an aspect of the disclosure that the coupon use information can be collected and used by the retailer while the customer remains anonymous. Such information can include but is not limited to, combinations of coupons used by the same customer in a single shopping trip, or coupons used by a customer over more than one shopping trip if the tag is kept by a customer and used in one or more subsequent shopping trips.

The system further includes a plurality of shelf devices that store coupon information and transfer information to the customer tags. Two types of shelf units shown in FIG. 1 include a wireless shelf unit 14 and a shelf unit 16 that does not include wireless communication capability. As shown in FIG. 1, a wireless shelf unit can communicate directly with a shelf unit communication server 18 as well as with the customer tag. Any appropriate wireless network protocol can be used in the practice of the disclosed systems and methods. In certain embodiments a wireless communication network is a low power, 900 mHz RF system. The use of such a device allows the remote programming of a shelf unit, to add or change coupon information, for example. The server can also remotely identify the shelf units. In certain embodiments, the shelf unit communication server can also collect information from the shelf units regarding customer response to the coupon offers and could track a customer tag's route through the store if multiple coupons are accepted by a single tag. Other uses of the information are also available.

In certain embodiments, a simpler shelf unit does not include wireless communication capability. As shown in FIG. 1, such as shelf unit can be programmed by a typically hand held or mobile near field communication (NFC) device 20 for entering coupon information. Such shelf units can also be identified by a barcode such that a barcode scanner 22 is used to identify shelf units and communicate their location or status to the shelf unit communication server 18 as also shown in FIG. 1. In practice, the mobile NFC device is programmed with the coupon data. This can be accomplished by scanning a paper coupon, by wireless communication, for example, or by other entry methods. The device then scans a shelf unit barcode to obtain the shelf unit barcode number. The shelf unit barcode is then associated with the coupon information. When a customer taps the shelf unit, that same barcode number is written to the customer tag and the discount is applied when the point of sale device reads the number from the tag and applied the appropriate discount to the customer's bill.

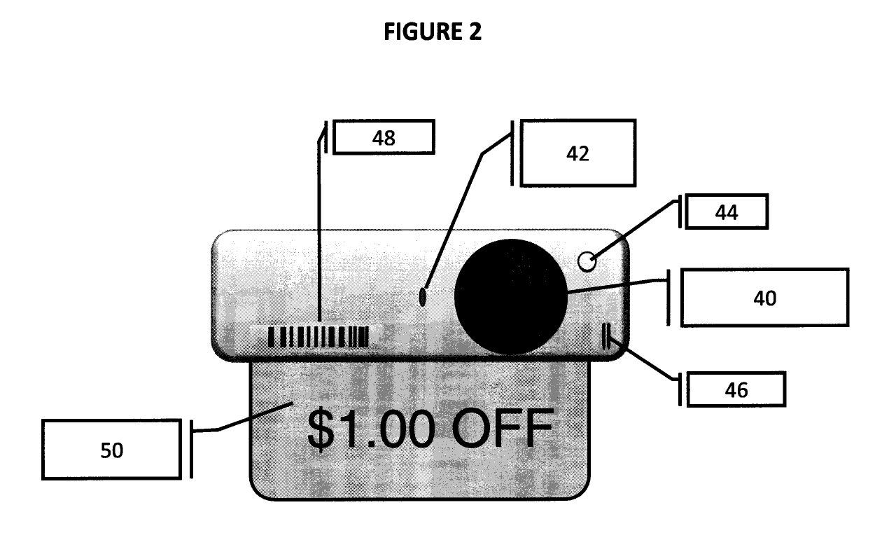

An example of the face portion of a shelf unit 16 is shown in FIG. 2. The face of the shelf unit includes a button 40 that can be tapped by a tag to transfer coupon information to read information from the tag and to transfer information to the tag. The shelf unit contains an RFID reader/writer that is activated when a customer tag is tapped on the indicated location. The reader/writer can receive information from the tag and can write the coupon data to the tag. In certain embodiments the reader determines whether the tag belongs to that retail store or to another. When use of a tag is attempted in the wrong store, The shelf unit will not transfer coupon information an can wipe all information from the tag so the tag cannot be improperly used.

The shelf unit further includes a proximity sensor 42 for detecting the presence of a customer. In certain embodiments, the device can reside in standby mode until the proximity sensor detects a customer, causing the device to power up. The device can further include indicators, such as an LED 44 and/or a speaker 46. These indicators tell a customer that the coupon information has been successfully transferred to the tag by either a blinking LED or by emitting a beep or sound through the speaker. The face of the shelf unit can also include a barcode 48 for identifying the shelf unit. The shelf unit face can also include an advertising tag 50, that provides coupon information to a customer and can also include copy to encourage customers to use the coupon, or any other information such as logos or other advertising. The shelf units can be powered by battery such as a lithium ion battery, for example, or they can be hard-wired in certain embodiments.

The system illustrated in FIG. 1 also includes a shelf unit management server 24 in electronic communication with the shelf unit communication server 18, a point of sale interface module 26 in electronic communication with the shelf unit management server 24 and a point of sale near field communication reader 28 in electronic communication with the point of sale interface module 26. It is understood that although these system components are shown and described separately, one or more of these components can reside in a single computer or device. Further, the devices can be connected to other devices such as a point of sale checkout device that are not shown in the drawings. It is further understood that the electronic connections between the devices can be through electronic circuits or through wireless connections.

The present disclosure can be described in certain embodiments as a method for providing electronic coupons to customers in a retail store. The method includes providing an RFID tag to customers to use while shopping in the retail store, providing one or more electronic devices on a shelf of the retail store near selected products, where the shelf device is programmed to detect the presence of a customer tag and to transmit discount pricing information for the selected product to the tag. The method further includes providing a point of sale checkout device, wherein the checkout device comprises or is connected to a module configured to read discount coupon data stored on the tag and to apply the discount data to a customer's balance upon checkout. In certain embodiments the method includes associating a tag to a customer's purchase information to provide additional advertising or coupons. Additional coupon information can be added to the tag, for example, for use in a future purchase. Information from the tag can also be collected by the store server to evaluate coupon programs.

It is an aspect of the disclosure that the coupons can be collected during a shopping trip and are available for immediate use during the same visit upon checkout. The methods are thus distinguished over methods in which coupons are only printed or provided at checkout for use in a subsequent shopping transaction, and methods of electronic coupon distribution in which a membership or registration is required in order to receive electronic coupons, typically prior to a store visit.

A further aspect of the disclosure is a point of sale device that is configured to extract the coupon data from a customer tag and apply the appropriate discounts to the purchased items. The point of sale checkout device can include computer readable media with instructions embedded thereon to read the coupon discount information; compare the coupon discount information to the list of items purchased; subtract the discount amounts from the cost of items for which coupon data has been loaded onto the tag; and providing a receipt to a customer that includes the coupon discounts.

An example of the use of an electronic coupon as disclosed includes, but is not limited to the following steps. A shelf unit is assigned to a promotion, such as a discount of 1 dollar from the cost of a unit of bananas. The shelf unit has an assigned number associated with that shelf unit, 1230567, for example. The shelf unit number can have been programmed either wirelessly, or with a mobile barcode scanner and NFC reader/writer. A database in a server, such as the point of sale server is programmed to recognize that when a tag with shelf number 1230567 is presented upon checkout, that is a coupon for $1.00 off a unit of bananas. An RFID tag is provided to a customer. The customer goes to the shelf and taps the tag against the shelf unit designated as 1230567. The shelf unit writes its ID number 1230567 onto the RFID tag. At the point of sale, the customer taps the tag against the point of sale reader. The shelf tag number is read by the reader and associated with the programmed data, 1230567=$1.00 a unit of bananas. The point of sale device clears the tag and applies the discount to a unit of bananas when that appears in the list of sale items. The applied discount can then be indicated on the customer receipt.

The systems and methods of the disclosure can also include additional promotional materials, both at the entrance to the store and at the various shelf locations. A store can provide, for example, a list of items or locations in the store where electronic coupons are available as well as information at the shelf locations that directs a customer to a particular brand, size or quantity of product and can also direct customers to related products that may also have electronic coupons available. In certain embodiments, for example, an electronic device on the shelf can include a front surface that displays coupon and price information, and such display can also be provided by an electronic display, such as a display including a light emitting diode. The electronic device on the shelf can also include a “tag me” area such that placing a tag on or adjacent the tag area causes the tag to be within the broadcast zone of the electronic shelf device, resulting in transfer of coupon information from the electronic device on the shelf to the tag.

The present disclosure can also be described in certain embodiments as a system for providing coupons to shoppers in a retail setting. Such systems can include an RFID device configured to attach to a retail grocery shelf, the device comprising an electronic circuit that functions as an RFID reader/writer, a proximity sensor, a battery and a GUID barcode; an electronic tag comprising an RFID reader/writer and a GUID bar code; a point of sale checkout device that includes an RFID reader, a computer readable media with instructions embedded therein to read the coupon discount information from an electronic tag, compare the coupon discount information to the list of items purchased; subtract the discount amounts from the cost of items for which coupon data has been loaded onto the tag; and provide a receipt to a customer that includes the coupon discounts. The system can further include a point of sale server connected to the point of sale checkout device comprising a database for storing coupon use information. The point of sale server can include databases and connections that are known in the art such as sales and inventory information and can be connected to a large area network to process data or to provide data related to multiple store locations.

The disclosed methods can include methods of promoting selected products to customers in a retail grocery store comprising providing customers with an RFID tag for use while shopping and providing one or more wireless devices on grocery shelves near the selected products, wherein customers can receive coupons by placing the tag near the wireless device to transfer coupon discount information to the tag, and further wherein the coupon discount information is read by a device at the point of sale such that the coupon discounts are subtracted from the total cost for the selected products, thus providing a simplified and convenient couponing method for customers that does not include cutting paper coupons, or obtaining electronic coupons in advance. The methods can also be described as methods of distributing coupons electronically in a retail grocery store comprising providing an RFID device on a grocery shelf that is configured to transfer coupon discount information to a customer tag, wherein the coupon can be redeemed immediately.

Although other types of devices known in the art, such as those that use sound or light can be used, the use of RFID is a preferred technology for the practice of the disclosed systems and methods. The purpose of an RFID system is to enable data to be transmitted by a portable device, called a tag, which is read by an RFID reader and processed according to the needs of a particular application.

A typical RFID tag consists of a microchip attached to a radio antenna mounted on a substrate. The antenna emits radio signals to activate the tag and to read and write data to it. A reader is required to retrieve the data that is stored on a tag. A typical reader is a device that has one or more antennas that emit radio waves and receive signals back from the tag. The reader then passes the information in digital form to a computer system. In the present disclosure, the electronic shelf device comprises both a reader and a writer so that coupon information can be stored in the device and that information can be transmitted to the customer's tag. In certain embodiments, the reader emits radio waves in ranges of anywhere from one inch to 100 feet or more, depending upon its power output and the radio frequency used. As used herein, the effective range of radio waves for a device is also referred to as the broadcast zone. In the present disclosure, the reader emits RF waves at a low data rate, and provide long battery life and secure networking.

In preferred embodiments, the point of sale device also includes an RFID reader. This reader decodes the coupon data encoded in the tag's integrated circuit (silicon chip) and the data is passed to the host computer for processing.

The types of tags that can be used with the present disclosure include HF (High Frequency) Tags, Labels and Cards that operate at a frequency of 13.56 MHz. These types of tags are defined as passive, as they have no independent power source. RFID applications that use HF RFID tags are typically the applications that require read distances of less than three feet.

Another appropriate type of tag is the LF (Low Frequency) Tags, Labels and Cards. The low frequency tags operate at low-frequency (125 khz) and thus use less power. This range is also better able to penetrate non-metallic substances. These types of tags are also passive and have a read range of less than a foot.

While particular embodiments of the invention and method steps of the invention have been described herein in terms of preferred embodiments, additional alternatives not specifically disclosed but known in the art are intended to fall within the scope of the disclosure. Thus, it will be apparent to those of skill in the art that variations may be applied to the devices and/or methods and in the steps or in the sequence of steps of the methods described herein without departing from the concept, spirit and scope of the invention. All such similar substitutes and modifications apparent to those skilled in the art are deemed to be within the spirit, scope and concept of the invention as defined by the appended claims.

1. A method for providing electronic coupons to customers in a retail store comprising:
providing an electronic device on a shelf of the retail store near a selected product, where the device includes an identification indicator, where the device comprises an electronic circuit, a power supply, and an antennae for wireless transmission and/or reception of information to a broadcast zone, where the electronic circuit detects the presence of a customer tag in the vicinity and transmits its identification indicator to the electronic tag;
providing an electronic tag to customers to use while shopping in the retail store, where the tag comprises an electronic circuitry configured to transmit information and to receive and store information and an antennae for wireless transmission and/or reception of information, wherein the tag reads and stores shelf unit information when placed within the broadcast zone of the shelf unit; and
providing a point of sale checkout device, wherein the checkout device comprises electronic circuitry configured to read shelf unit identifiers stored on the tag and to associate coupon discount data associated with the shelf unit to a customer's balance upon checkout.

2. The method of claim 1, further comprising providing a point of sale server electronically connected to the point of sale checkout device, wherein the server is configured to read and save the discount coupon data from the checkout device.

3. The method of claim 1, wherein the power supply in the electronic device on a shelf is a battery.

4. The method of claim 1, comprising providing tags to customers for use during a single store visit and collecting the tags from customers at the point of sale.

5. The method of claim 1, comprising providing tags to customers for use in multiple shopping trips, and offering coupons based on coupon use history.

6. The method of claim 5, comprising providing a kiosk comprising an electronic reader/writer, such that placing an RFID tag within a broadcast zone of the kiosk reader/writer is effective to transfer previous coupon use with the tag, and to transfer coupon identifier numbers to the tag based on the previous coupon use.

7. The method of claim 1, wherein the shelf unit identification indicator is a barcode.

8. The method of claim 1, wherein the shelf unit comprises an indicator device that activates to indicate that data has been transferred to a tag.

9. The method of claim 8, wherein the indicator is an LED device that blinks or flashes to indicate that data has been transferred to a tag.

10. The method of claim 8, wherein the indicator is a speaker that beeps provides an audio signal to indicate that data has been transferred to a tag.

11. The method of claim 1, wherein the point of sale checkout device comprises computer readable media with instructions embedded thereon to:
read a shelf unit identifier;
compare the shelf unit identifier with a database of coupon discounts associated with shelf units to identify a discount associated with the shelf unit identifier;
compare the coupon discount information to the list of items purchased;
subtract the discount amount from the cost of an item for which a coupon has obtained; and
provide a receipt to a customer that indicates the coupon discount.

12. The method of claim 1, wherein the electronic shelf device comprises a surface that includes a display of item and discount information.

13. The method of claim 1, wherein the electronic shelf device comprises a surface that includes a tag area configured such that placing a tag on or adjacent the tag area causes the tag to be within the broadcast zone of the electronic shelf device.

14. The method of claim 13, wherein placing a tag on or adjacent the tag area results in transfer of shelf unit information from the electronic device on the shelf to the tag.

15. A system for providing coupons to shoppers in a retail setting comprising:
an RFID device configured to attach to a retail grocery shelf, the device comprising an electronic circuit that functions as an RFID reader/writer, a proximity sensor, a power supply and an associated device identifier;
an electronic tag comprising an RFID chip and an electronic reader/writer; and
a point of sale checkout device comprising an RFID reader/writer, a computer readable media with instructions embedded therein to read a shelf device identifier store on an RFID tag, to associate the shelf identifier with a discount coupon, to compare the coupon discount information to the list of items purchased; to subtract the discount amount from the cost of the item; and to provide a receipt that includes the coupon discount.

16. The system of claim 15, further comprising a point of sale server connected to the point of sale checkout device comprising a database for storing coupon use information.

17. A method of promoting a sale of a selected product to customers in a retail grocery store comprising providing customers with an RFID tag for use while shopping and providing one or more electronic devices on grocery shelves near the selected products, wherein customers can receive coupons by placing the tag near the shelf device to transfer coupon discount information to the tag, and further wherein the coupon discount information is read by a device at the point of sale such that the coupon discounts are subtracted from the total cost for the selected products.

18. A system for providing coupons to customers in a retail grocery setting, the system comprising:
one or more electronic RFID devices configured to attach to a grocery shelf, wherein the electronic devices each comprise an identifier number, and electronic circuitry effective to transfer the identifier number to an RF receiver placed in a broadcast zone of the device;
one or more RFID tags comprising electronic circuitry effective to receive and store information broadcast by the shelf unit device; and
one or more point of sale devices, each comprising an RFID device unit effective to read shelf unit data from an RFID tag and to identify the shelf unit information with an associated coupon discount; and to apply the discount to purchased items.

19. A method of distributing coupons electronically in a retail grocery store comprising providing an RFID device on a grocery shelf that is configured to transfer information associated with a discount on a selected item to a customer tag, wherein the coupon can be redeemed immediately to receive a discount on the selected item.
